(19) United States
(12) Patent Application Publication
(10) Pub. No.: US 2025/0389295 A1
(43) Pub. Date: Dec. 25, 2025

(54) Dock Coupler

(71) Applicant: Sandy McDonald, Breslau (CA)

(72) Inventor: Sandy McDonald, Breslau (CA)

(21) Appl. No.: 19/237,365

(22) Filed: Jun. 13, 2025

Related U.S. Application Data
(60) Provisional application No. 63/663,730, filed on Jun. 25, 2024.

(51) Int. Cl. F16C 11/04; E02B 3/06

(52) U.S. Cl. CPC F16C 11/04; E02B 3/064; E02B 2201/00

(57) ABSTRACT

A dock coupler to couple a first dock element to a second dock element includes a first connector having a pin and configured to be coupled to the first dock element, and a second connector configured to be coupled to the second dock element. The second connector includes a rod defining a slot to receive the pin to enable the removable engagement of the first connector to the second connector. The engagement of the second connector and the first connector facilitates a yaw, a pitch, and a roll motion of the second dock element relative to the first dock element.

### RELATED APPLICATION

This application claims benefit of U.S. Provisional Patent Application 63/663,730, filed on Jun. 25, 2024, the disclosure of which is hereby incorporated herein by reference in its entirety.

### BACKGROUND OF THE INVENTION

### 1. Technical Field

The present disclosure relates, generally, to a dock coupler, and more particularly relates to a dock coupler suitable for coupling one dock element to another dock element.

### 2. Description of the Prior Art

Many waterfront properties have floating docks that are typically connected to stationary landings or adjacent floating docks by connecting ramps that provide a catwalk that moves up and down with fluctuating water levels. Stationary landings, connecting ramps and floating docks are fitted with dock hinges to facilitate these connections. Connecting ramps often require annual connection/disconnection to protect the dock system from damage caused by winter weather and ice.

Currently available dock hinges commonly consist of matched male and female plates pinned together. These hinges allow the connecting ramp to pitch up and down. In order to be connected, these hinges need to be closely aligned in X, Y and Z directions as well as the yaw and roll axes for pins with minimal clearance to be inserted into the plates. Connecting ramps and floating docks are heavy and difficult to maneuver. Conditions during ramp connection/disconnection are often challenging due to shoreline terrain, temperature, wind and waves. All of these issues make the connection/disconnection process difficult and likely to require multiple people to accomplish the alignment and pinning of the hinges.

### SUMMARY OF THE INVENTION

In one aspect of the disclosure, a dock coupler to couple a first dock element to a second dock element is disclosed. The dock coupler includes a first connector having a pin and configured to be coupled to the first dock element. The dock coupler also includes a second connector configured to be coupled to the second dock element. The second connector includes a rod defining a slot to receive the pin to enable the removable engagement of the first connector to the second connector. The engagement of the first and second connectors facilitates a yaw, a pitch, and a roll motion of the second dock element relative to the first dock element.

In some additional, alternative, or optional embodiments, the second connector includes a swivel socket extending inside the slot and adapted to swivel relative to the rod to facilitate the yaw, the pitch, and the roll motion of the second dock element relative to the first dock element.

In some additional, alternative, or optional embodiments, the pin defines a radially extending opening to receive a lynch pin to lock the first connector with the second connector to prevent any undesired removal of the pin from the slot.

In some additional, alternative, or optional embodiments, the first connector includes a flange adapted to be connected to the first dock element to secure the first connector to the first dock element, and the second connector includes a plate adapted to be connected to the second dock element to secure the second connector to the second dock element.

In some additional, alternative, or optional embodiments, the slot is an elliptical slot a major axis greater than a diameter of the pin to enable the roll motion.

In some additional, alternative, or optional embodiments, the second connector includes a pair of arms arranged spaced apart and parallel to each other, and the rod extends between the arms and extends through the arms. The arms are arranged to rotate about a central axis of the rod to enable the pitch motion of the second dock element relative to the first dock element.

In some additional, alternative, or optional embodiments, the rod is adapted to rotate about a central axis of the pin facilitate the yaw motion of the second dock element relative to the first dock element.

According to some aspects of the disclosure, a dock system is disclosed. The dock system includes a first dock element, a second dock element, and a pair of dock couplers removably coupling the first dock element to the second dock element. Each of the pair of dock couplers includes a first connector attached to the first dock element and including a pin, and a second connector attached to the second dock element. The second connector includes a rod defining a slot, and the pin extends through the slot, removably engaging the first connector to the second connector. A yaw, a pitch, and a roll motion of the second dock element relative to the first dock element is enabled upon engagement of associated first and second connectors of one of the pair of dock couplers to enable an easy alignment and engagement of associated first and second connectors of another of the pair of dock couplers.

In some additional, alternative, or optional embodiments, the second connector of each of the pair of dock couplers includes a swivel socket extending inside the slot and adapted to swivel relative to the rod to facilitate the yaw, the pitch, and the roll motion of the second dock element relative to the first dock element.

In some additional, alternative, or optional embodiments, the pin defines a radially extending opening to receive a lynch pin to lock the first connector with the associated second connector to prevent any undesired removal of the pin from the slot.

In some additional, alternative, or optional embodiments, the first connector of each of the pair of dock couplers includes a flange adapted to be connected to the first dock element to secure the first connector to the first dock element, and the second connector of each of the pair of dock couplers includes a plate adapted to be connected to the second dock element to secure the second connector to the second dock element.

In some additional, alternative, or optional embodiments, the slot is an elliptical slot a major axis greater than a diameter of the pin to enable the roll motion.

In some additional, alternative, or optional embodiments, the second connector of each of pair of dock couplers includes a pair of arms arranged spaced apart and parallel to each other, and the rod extends between the arms and extends through the arms. The arms are arranged to rotate about a central axis of the rod to enable the pitch motion of the second dock element relative to the first dock element.

In some additional, alternative, or optional embodiments, the rod is adapted to rotate about a central axis of the pin facilitate the yaw motion of the second dock element relative to the first dock element.

In some embodiments, the first dock element is one of a stationary landing, a connecting ramp, or a floating dock.

In some embodiments, the second dock element is one of a stationary landing, a connecting ramp, or a floating dock.

The dock coupler allows for easy connection/disconnection of the dock elements by utilizing a joint that is forgiving to align and easy to latch without tools. When connected, the dock coupler provides a secure connection between the dock elements while allowing angular motion at the joints or a vertical motion at the joints caused by fluctuating water levels.

### BRIEF DESCRIPTION OF FIGURES

FIG. 1 illustrates a dock coupler having a first connector and a second connector engaged with each other in accordance with an embodiment of the disclosure;

FIG. 2 illustrates an exploded view of the dock coupler depicting the first connector and the second connector separated from each other, in accordance with an embodiment of the disclosure;

FIG. 3 illustrates a typical dock system with a stationary landing, a floating dock, and a connecting ramp arranged between the stationary landing and the floating dock and coupled to the stationary landing and the floating dock, in accordance with an embodiment of the disclosure;

FIG. 4 illustrates a stationary landing and a pair of first connectors of a first pair of dock couplers attached to the stationary landing, in accordance with an embodiment of the disclosure;

FIG. 5 illustrates a connecting ramp and a pair of second connectors of the first pair of dock couplers mounted to a first side of the connecting ramp and adapted to be engaged with the first connectors of FIG. 4, in accordance with an embodiment of the disclosure;

FIG. 6 illustrates the connecting ramp and a pair of second connectors of a second pair of dock couplers mounted to a second side of the connecting ramp, in accordance with an embodiment of the disclosure;

FIG. 7 is a view of the second connector attached to the connecting ramp with X, Y, Z, Yaw, Pitch and Roll motion shown, in accordance with an embodiment of the disclosure.

FIG. 8 illustrates a floating dock and a pair of first connector of the second pair of dock couplers and mounted to the floating dock and adapted engaged with the pair of second connectors arranged on the second side of the connecting ramp of FIG. 6, in accordance with an embodiment of the disclosure;

FIG. 9 illustrates a front top perspective view of a dock coupler, in accordance with an embodiment of the disclosure; and

FIG. 10 illustrates a top perspective view of the dock coupler, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

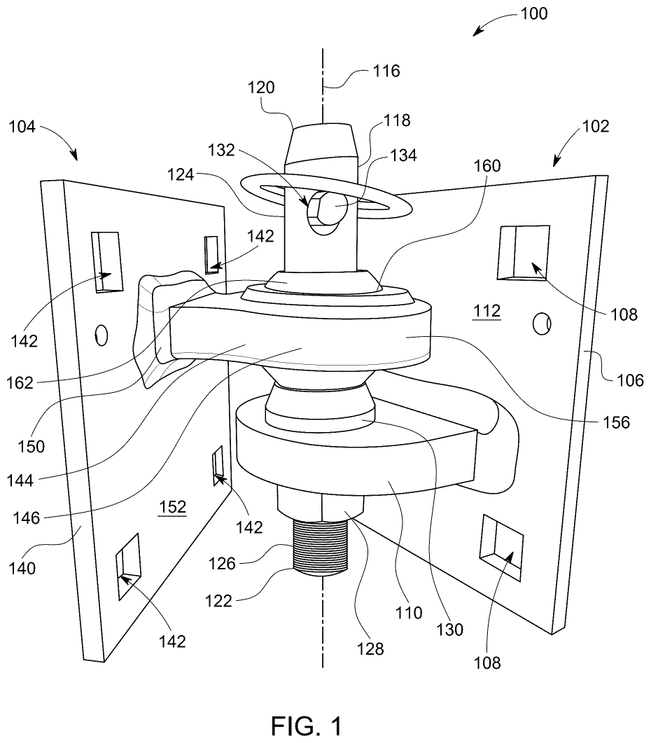

Referring to FIG. 1, a dock coupler 100 suitable to connect one dock element to another dock element is shown. In the embodiments, the dock element may be a stationary landing, a floating dock, or a connecting ramp. In some embodiments, the dock couplers 100 are used to connect a stationary landing to a floating deck. In some embodiments, the dock couplers 100 are used to connect the stationary landing to a connecting ramp, and the connecting ramp to the floating deck. The connecting ramp is generally arranged between the stationary landing and the floating deck. The dock coupler 100 may also be used to couple one floating deck to another floating deck.

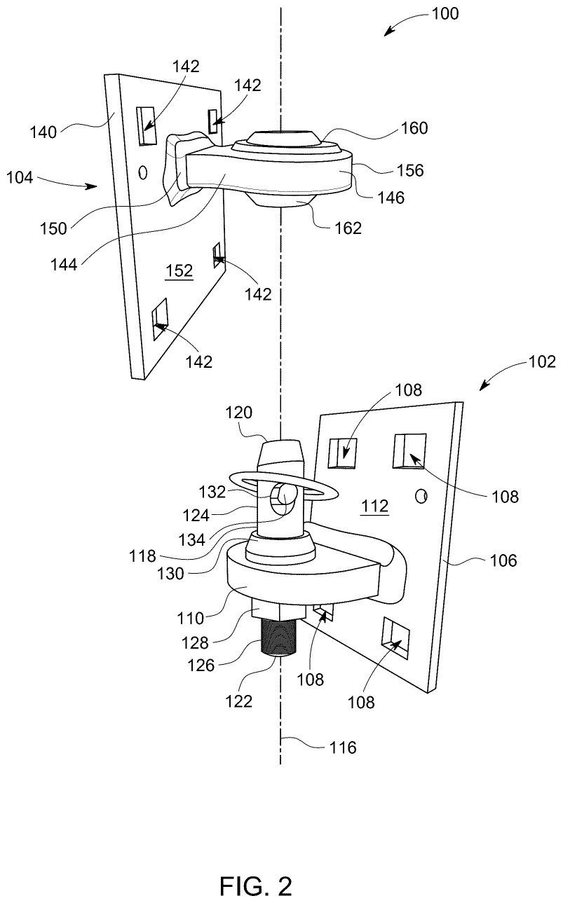

As shown in FIGS. 1 and 2, the dock coupler 100 includes a first connector 102 adapted to be attached to one dock element and a second connector 104 adapted to be secured to another element. In embodiments, the dock elements are removably engaged with each other by removably connecting the first connector 102 to the second connector 104. As shown in FIGS. 1 and 2, the first connector 102 includes a flange 106 configured to be mounted/attached/connected to the dock element via a plurality of fasteners. To facilitate the connection of the flange 106 with the dock element via the fasteners, the flange 106 defining a plurality of holes 108, and the fasteners extends into the dock element through the holes 108 to secure the first connector 102 with the dock element. As shown, the flange 106 is a square plate/flange having four holes 108 arranged at four corners of the flange 106, and the fasteners, for example, screws, nails, or bolts, may be inserted through the holes 108 to connect the flange 106 i.e., the first connector 102 with the dock element. Although, the flange 106 is shown as a square plate, it may be envisioned that the flange 106 may include any other shape, such as, but not limited to, rectangular, circular, oval, elliptical, trapezoidal, or any other suitable shape known in the art. It may be appreciated that the scope of the disclosure is not limited by the shape of the flange 106 that is used to connect the first connector 102 to the dock element. In some embodiments, the flange 106 may be welded to the dock element to connect the first connector 102 with the dock element.

Moreover, the first connector 102 includes an eye structure 110 connected to the flange 106 and extending substantially perpendicularly to a surface 112 of the flange 106. The eye structure 110 defines a groove extending through an entire thickness of the eye structure 110. The eye structure 110 is connected to the flange 106 such that a central axis of the groove is substantially parallel to the surface 112 of the flange 106 and extends in a vertical direction. In some embodiments, the eye structure 110 is connected to the dock element, and in such a case, the flange 106 may be omitted. Further, the first connector 102 includes a pin 118 extending through the groove of the eye structure 110 and connected to the eye structure 110. As shown, the pin 118 includes a first end 120 arranged on a first side of the eye structure 110 and a second end 122 disposed on a second side opposite to the first side of the eye structure 110. The pin 118 includes a first portion 124 extending from the eye structure 110 to the first end 120 and a second portion 126 extending from the eye structure 110 to the second end 122.

In some embodiments, the second portion 126 may include threads to enable an engagement a nut 128 around the second portion 126 to couple/connect the pin 118 with eye structure 110. The engagement of the nut with the second portion 126 prevents a removal of the pin 118 from the eye structure 110. Moreover, the first connector 102 includes a sleeve 130 arranged inside the groove of the eye structure 110 and connected to the eye structure 110. The pin 118 extends through the sleeve 130, and the sleeve 130 facilitates the retention of the pin 118 with the eye structure 110. In some embodiments, the pin 118 and/or sleeve 130 may be arranged and adapted to swivel about the central axis 116 of the groove. Although, the pin 118 is shown to be separate from the eye structure 110, it may be envisioned that the pin 118 may be integrally formed with the eye structure 110. Moreover, the pin 118 defines a radially extending opening 132 arranged proximate to the first end 120 to removably receive a lynch pin 134 to prevent any undesired disengagement of the first connector 102 and the second connector 104. Although the lynch pin 134 is shown and contemplated, it may be envisioned that any other similar or suitable locking structure, known in the art, that locks the first connector 102 and the second connector 104 and prevent any disengagement of the pin 118 from the second connector 104 may also be utilized.

Still referring to FIGS. 1 and 2, the second connector 104 includes a plate 140 adapted to removably engage the second connector 104 to another dock element, also referred to as second dock element. The plate 140 includes a plurality of openings 142 to enable an insertion of the plurality of fasteners, for example, screws, into the second dock element to enable the engagement of the second connector 104 with the second dock element. In the illustrated embodiment, the plate 140 is a square plate having four openings 142 arranged at four corners of the plate 140. Although, the plate 140 is shown and contemplated as the square plate, it may be envisioned that the plate 140 may include any other shape, such as, but not limited to, rectangular, oval, elliptical, trapezoidal, or any other suitable shape known in the art, and the scope of the disclosure is not limited by the shape of the plate 140. In some embodiments, the plate 130 may be welded to the dock element to connect the second connector 104 with the dock element.

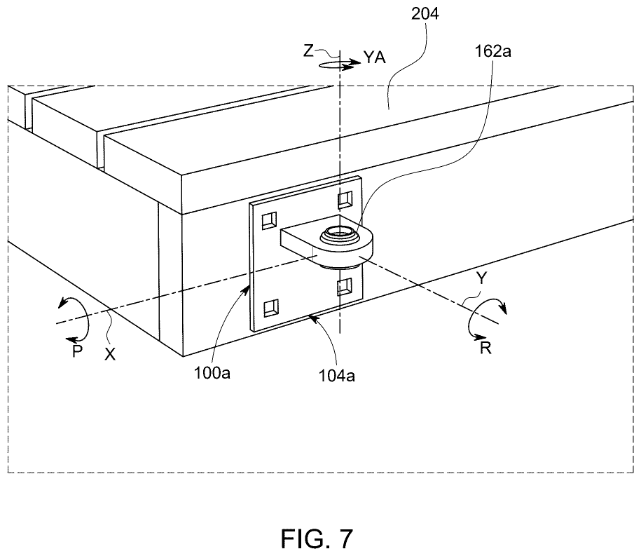

Further, the second connector 104 includes a rod 144, for example, a fisheye rod 146, coupled to the plate 140. In the embodiment, the rod 144 has a first end 150 attached to a surface 152 of the plate 140 and extending substantially perpendicularly to the surface 140 of the plate 140, and a second end 156 arranged away from the plate 140. The rod 144 defines a through slot 160 extending in a vertical direction. In the embodiment, the slot 160 is arranged proximate to the second end 156 of the rod 144. In some embodiments, the rod 144 is connected to the dock element, and in such a case, the plate 140 may be omitted. Furthermore, the second connector 104 includes a ball swivel type socket 162 arranged inside, at least partially, the slot 160 of the rod 144 and engaged to the rod 144. The socket 162 is arranged to swivel inside the groove 160 relative to the rod 144 to allow the Pitch, Roll, and Yaw movement of the socket 162 relative to the rod 144 to allow the Pitch ‘P’, Roll ‘R’, and Yaw ‘YA’, shown in FIG. 7, movement of the associated dock element during assembly of the associated dock element with other dock element to which the first connector 102 is secured.

In an assembly of first connector 102 and the second connector 104, as shown in FIG. 1, the rod 144 of the second connector 104 is arranged vertically above the eye structure 110 of the first connector 102 such that the first portion 124 of the pin 118 of the first connector 102 extends through the socket 162 of the second connector 104. Moreover, a lynch pin 134 of the dock coupler 100 extends through a radially extending opening 132 of the pin 118 to lock the second connector 104 with the first connector 102 and to prevent any undesired disengagement of the first connector 102 and the second connector 104.

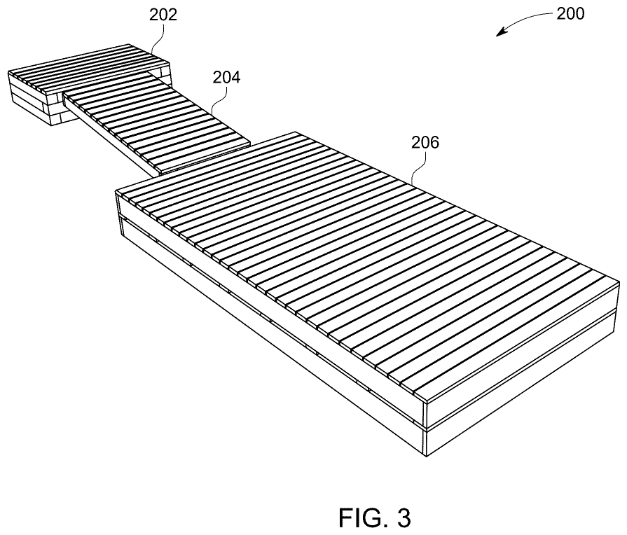

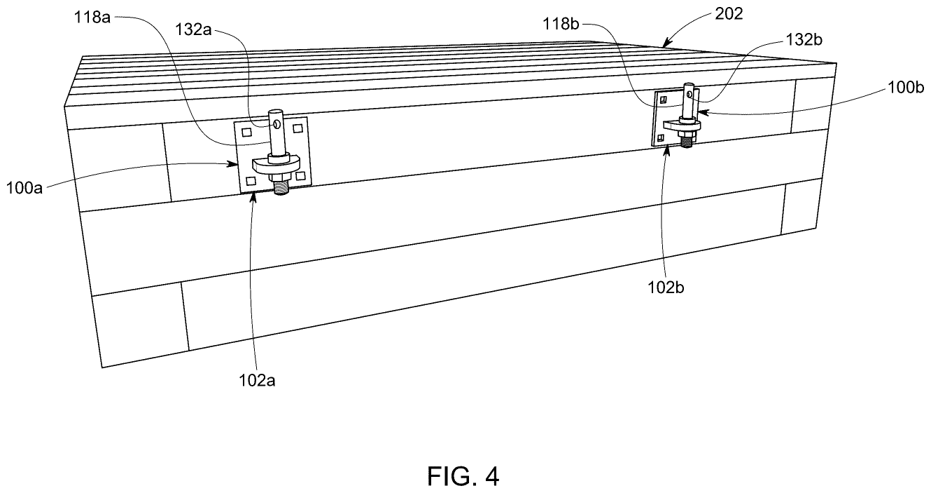

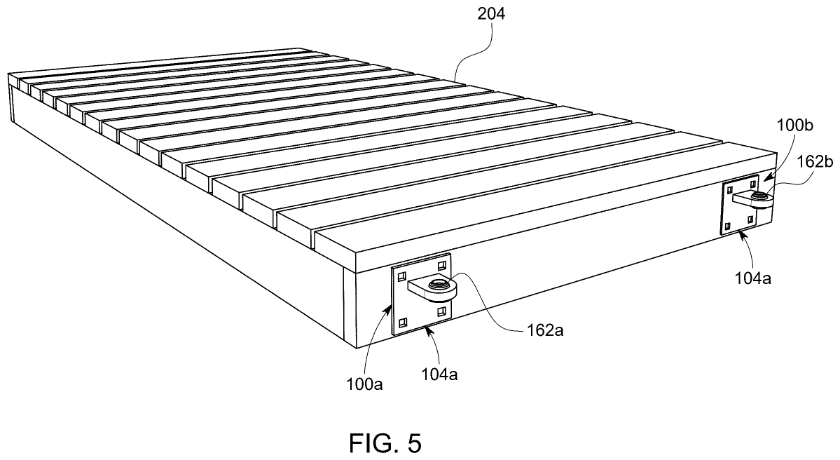

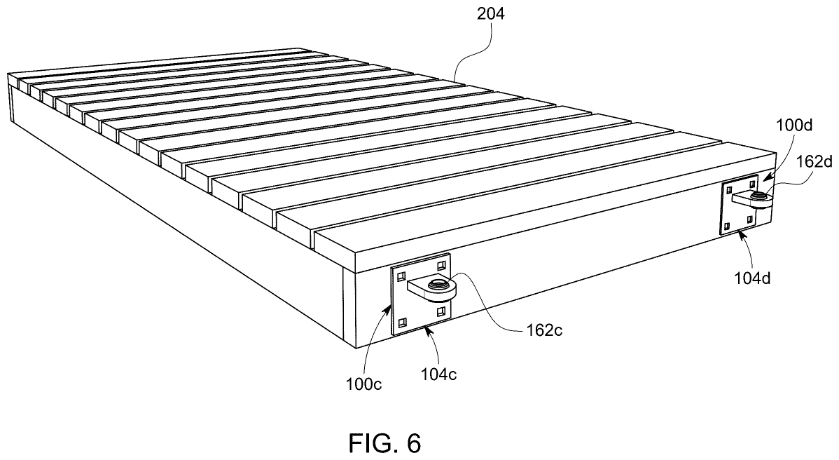

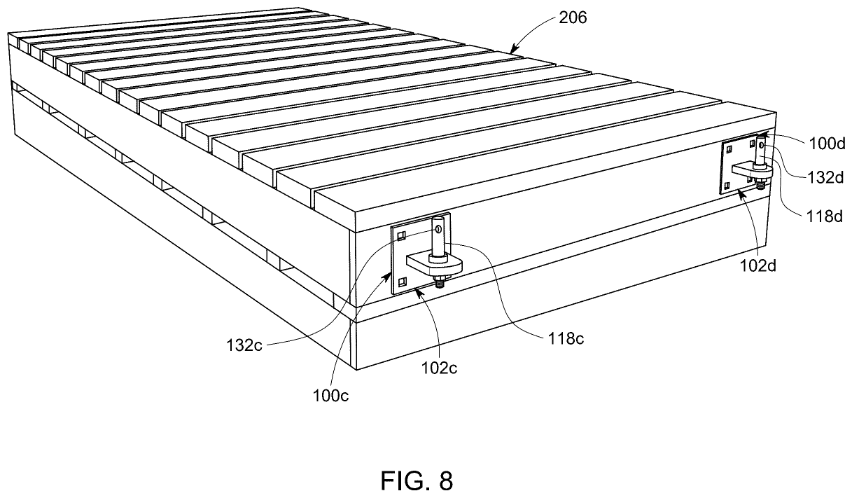

Referring to FIG. 3, a dock system 200 is shown according to an example embodiment of the disclosure. The dock system 200 includes a first dock element 202, for example, stationary landing 202, a second dock element 204, for example, a connecting ramp 204, and a third dock element 206, for example, a floating dock 206. The connecting ramp 204 arranged between the stationary landing 202 and the floating dock 206 and couples the stationary landing 202 and the floating dock 206. In the embodiment, the connecting ramp 204 is connected to the stationary landing 202 via a first pair of dock couplers 100a, 100b, shown in FIGS. 4 and 5, and the connecting ramp 204 is connected to the floating dock 206 via a second pair of dock couplers 100c, 100d, shown in FIG. 6 and FIG. 8. The dock couplers 100a, 100b, 100c, 100d facilitate an easy attachment and detachment of the connecting ramp 204 with the stationary landing 202 and the floating dock 206. It may be appreciated that dock couplers 100a, 100b, 100c, 100d are identical to the dock coupler 100 and are suitable of connection two dock elements where fluctuating water levels create vertical motion between the various elements. The elements of the first, second, third, and fourth dock couplers are referred with similar reference number except that the reference numbers of the elements associated with the first dock coupler 100a are suffixed with ‘a’, the reference numbers of the elements associated with the second dock coupler 100b are suffixed with ‘b’, the reference numbers of the elements associated with the third dock coupler 100c are suffixed with ‘c’ and the reference numbers of the elements associated with the fourth dock coupler 100d are suffixed with ‘d’.

In the illustrated embodiment, second connectors 104a, 104b of first pair of dock couplers, i.e., first dock coupler 100a and the second dock coupler 100b, are arranged on a first side of the connecting ramp 204 and attached to the connecting ramp 204, as shown in FIG. 5, to connect the connecting ramp 204 to the stationary landing 202, while second connectors 104c, 104d, shown in FIG. 6, of the second pair of dock couplers, i.e., third dock coupler 100c and fourth dock coupler 100d, are arranged on a second side of the connecting ramp 204 and connected to the connecting ramp 204, to enable the connection of the connecting ramp 204 with the floating dock 206. Also, first connectors 102a, 102b of the first pair of dock couplers 100a, 100b are connected to the stationary landing 202, shown in FIG. 4, and first connectors 102c, 102d of the second pair of dock couplers 100c, 100d are connected to the floating deck 206, shown in FIG. 8. In the assembly of the connecting ramp 204 with the stationary landing 206 and the floating dock 206, the first connector 102a, 102b are arranged connected to the second connectors 104a, 104b, engaging the connecting ramp 204 with the stationary landing 202, and the second connectors 104c, 104d are arranged connected to the first connector 102c, 102d, securing the connecting ramp 204 with the floating dock 206.

A method to connect the stationary landing 202, connecting ramp 204, and floating dock 206 is now described. Initially, a technician, may connect the connecting ramp 204 to the stationary landing 202 via the first pair of dock couplers 100a, 100b. For so doing, the technician may set/position socket 162a of the second connector 104a of the first dock coupler 100a above and aligned with pin 118a of the first connector 102a of the first dock coupler 100a, and inserts and extends the pin 118a through the socket 162a by lowering the connecting ramp 204. Thereafter, the technician inserts lynch pin of the first connector 102a inside opening 132a of the pin 118a to secure the first connector 102a with the second connector 104a. Subsequently, the technician couple the second connector 104b of the second dock coupler 100b with the first connector 102 of the second dock coupler 100b.

As the socket 162 is arranged to swivel to allow Pitch ‘P’, Roll ‘R’ and Yaw ‘Ya’ motion to the connecting ramp 204 relative to the stationary landing 202, the advantage of this is that with the first dock coupler 100a of the first pair of dock couplers 100a, 100b connected, free Yaw, Pitch and Roll movement allows the connecting ramp 204 to be rotated relative to the stationary landing 202 to align the second connector 104b and the first connector 102b of the second dock coupler 100b without the installer being required to support a significant weight. When first connectors 102a, 102b and the second connectors 104a, 104b of the both the dock couplers 100a, 100b are connected, the motion of the dock couplers 100a, 100b i.e., dock elements 202, 204 is restricted to the pitch motion. Accordingly, dock couplers significantly reduce the effort, time and risk of injury when connecting/disconnecting the elements of the dock system as only one dock coupler needs to be connected at a time.

To couple/engage/secure the second connector 104b of the second dock coupler 100b with first connector 102b of the second dock coupler 100b, the technician may rotate the connecting ramp 204 relative to the stationary landing 202 to position the socket 162b of the second connector 104b above and aligned with the pin 118b of the first connector 102b. Once the pin 118b is inserted inside the socket 162b, the technician secures the second connector 104b with the first connector 102b by extending lynch pin 134b though opening 132b of the pin 118b. In this manner, the connecting ramp 204 is secured to the stationary landing 202.

Now, the technician couples/attaches the connecting ramp 204 to the floating dock 204 via the second pair of dock couplers 100c, 100d. For so doing, the technician aligns the socket 162c of the first connector 102c of the third dock coupler 100c and pin 118c of the second connector 104c of the third dock coupler 100c, and then inserts the pin 118c inside the socket 162c, and secures the first connector 102c with the second connector 104c by extending lynch pin 134c through opening 132c of the pin 118c. Subsequently, the technician couples second connector 104d of the fourth dock coupler 100d with first connector 102d of the fourth dock coupler 104d. For so doing, the technician rotates the floating dock 206 about both the yaw axis and roll axis relative to the connecting ramp 204 to position the socket 162d of the second connector 104d above and aligned with pin 118d of the first connector 102d, and extends the pin 118d through the socket 162d. Once the pin 118d is extended through the socket 162d, the technician secures the second connector 104d with the first connector 102d by extending lynch pin 134d though opening 132d of the pin 118d. In this manner, the floating dock 206 is attached to the connecting ramp 204.

Accordingly, the dock coupler 100 provides socket 162 adapted to swivel relative to the fisheye rod 110 to allow, with the one dock coupler of the pair of dock couplers connected, free Yaw, roll, and pitch movement of one dock element relative to other to align the first and second connectors of other dock coupler of the pair of dock couplers without the installer being required to support a significant weight. When the first and second connectors of both the dock couplers are connected, the motion of the dock couplers is restricted to the pitch motion. Accordingly, dock couplers significantly reduce the effort, time and risk of injury when connecting/disconnecting the elements of the dock system as only one dock coupler needs to be connected/disconnected at a time.

To disconnect the connecting ramp, the technician removes the lynch pins from the 4 dock couplers and lift each end of the connecting ramp free from the stationary landing and dock one end at a time. Although, the dock system 200 is shown to include the stationary landing 202, the connecting ramp 204, and the floating dock 206, It may be appreciated that that the dock system 200 may include any of two dock elements, and first connectors are attached to one of the two dock elements and second connectors are attached to other of two dock elements.

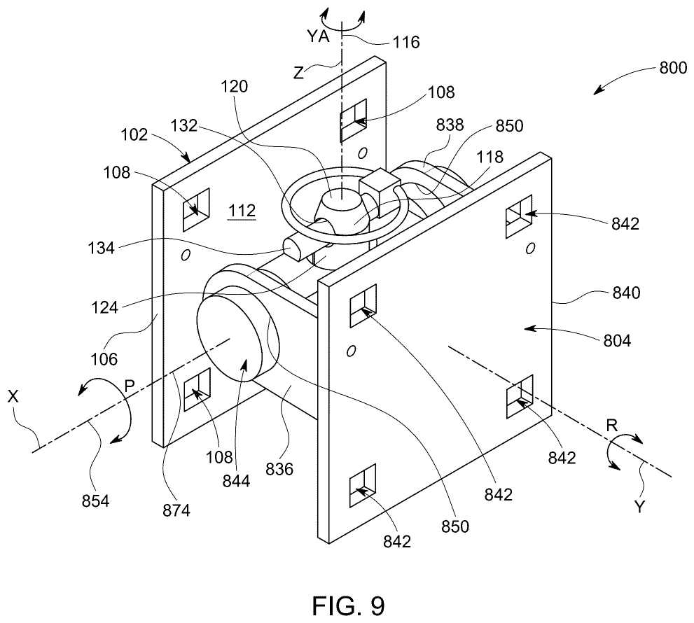

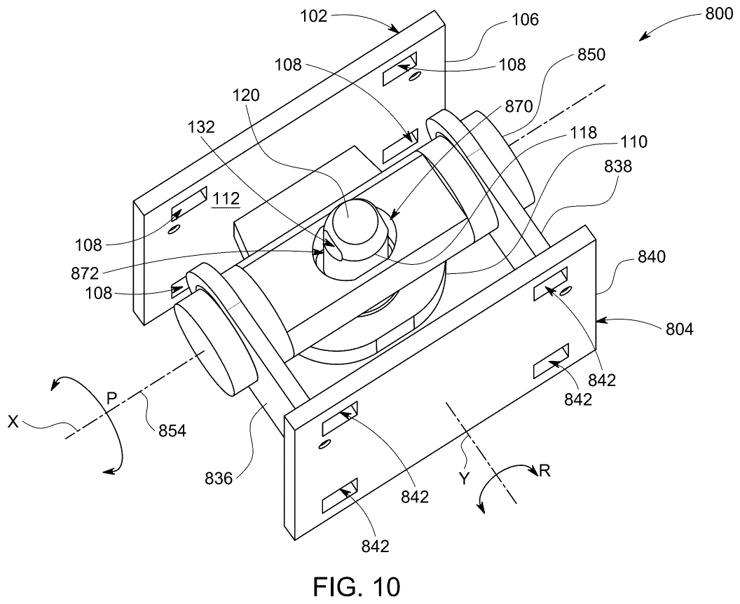

Referring to FIGS. 9 and 10, a dock coupler 800 is shown according to an alternative embodiment is shown. The dock coupler 800 is similar to the dock coupler 800 except that a second connector 804 of the dock coupler 800 is different from the second connector 104 of the dock coupler 100. As shown, the second connector 804 includes a plate 840 configured to be attached to the second dock element to secure the second connector 840 to the second dock element. To facilitate the engagement of the plate 840 with the second dock element, the plate 840 defines a plurality of openings 842, for example, four openings 842, through which a plurality of fasteners is extended inside the second dock element. In the illustrated embodiment, the plate 840 is shown as a square plate, however, it may be envisioned that the plate 840 may include any other shape, such as, but not limited to, rectangular, oval, circular, cylindrical, trapezoidal, or any other suitable shape known in the art. Also, it may be appreciated that the scope of the disclosure is not limited by the shape of the plate 840.

Further, the second connector 804 includes a pair of arms 836, 838 extending substantially perpendicularly to a surface of the plate 840, and arranged spaced apart and parallel to each other. As shown, first ends of the arms 836, 838 are arranged connected to the plate 840, while second ends of the arms 836, 838 are arranged distally from the plate 840. Also, each of the arms 836, 838 defines a hole 850 having a central axis 854 extending in a horizontal direction and is arranged substantially parallel to the surface of the plate 840. In the embodiment, holes 850 of the arms 836, 838 are arranged aligned with each other. Additionally, the second connector 804 includes a rod 844 arranged supported by the pair of arms 836, 838 and extending through the holes 850 of the arms 836, 838. As shown, the rod includes a slot 870 to receive the pin 118 of the first connector 102 to enable the engagement of the second connector 804 with the first connector 102. In the embodiments, the slot 870 is a substantially elliptical slot 872 having a major axis aligned with a central longitudinal axis 874 of the rod 844. Also, a length of the major axis is greater than a diameter of the pin 118 of the first connector 102 to enable a roll motion of one deck element relative to other deck element when the first connector 102 and the second connector 804 are engaged with each other. Also, in the assembly, the second connector 804 is adapted to pitch about the central axis 874 of the rod 844, while a rotation about a central axis 116 of the pin 118 provides yaw motion to one deck element relative to other deck element.

Other example joints types that provide the functionality covered by this disclosure for a dock coupler could be a ball and socket joint or a spherical bearing and pin.

Although the disclosure has been described in connection with a preferred embodiment, it should be understood that modifications, additions and alterations may be made to the disclosure by one skilled in the art without departing from the spirit and scope of the disclosure.

It should be understood that the foregoing description is only illustrative of the aspects of the disclosed embodiments. Various alternatives and modifications can be devised by those skilled in the art without departing from the aspects of the disclosed embodiments.

1. A dock coupler to couple a first dock element to a second dock element, the dock coupler comprising:
a first connector having a pin and configured to be coupled to the first dock element; and
a second connector configured to be coupled to the second dock element, the second connector includes a rod defining a slot to receive the pin to enable the removable engagement of the first connector to the second connector, wherein the engagement of the first and second connectors facilitates a yaw, a pitch, and a roll motion of the second dock element relative to the first dock element.

2. The dock coupler of claim 1, wherein the second connector includes a swivel socket extending inside the slot and adapted to swivel relative to the rod to facilitate the yaw, the pitch, and the roll motion of the second dock element relative to the first dock element.

3. The dock coupler of claim 1, wherein the pin defines a radially extending opening to receive a lynch pin to lock the first connector with the second connector to prevent any undesired removal of the pin from the slot.

4. The dock coupler of claim 1, wherein the first connector includes a flange adapted to be connected to the first dock element to secure the first connector to the first dock element, and the second connector includes a plate adapted to be connected to the second dock element to secure the second connector to the second dock element.

5. The dock coupler of claim 1, wherein the slot is an elliptical slot a major axis greater than a diameter of the pin to enable the roll motion.

6. The dock coupler of claim 1, wherein the second connector includes a pair of arms arranged spaced apart and parallel to each other, and the rod extends between the arms and extends through the arms, wherein the arms are arranged to rotate about a central axis of the rod to enable the pitch motion of the second dock element relative to the first dock element.

7. The dock coupler of claim 1, wherein the rod is adapted to rotate about a central axis of the pin facilitate the yaw motion of the second dock element relative to the first dock element.

8. A dock system, comprising:
a first dock element;
a second dock element;
a pair of dock couplers removably coupling the first dock element to the second dock element, each of the pair of dock couplers comprises
a first connector attached to the first dock element and including a pin, and
a second connector attached to the second dock element and including a rod defining a slot, wherein the pin extends through the slot, removably engaging the first connector to the second connector,
wherein a yaw, a pitch, and a roll motion of the second dock element relative to the first dock element is enabled upon engagement of associated first and second connectors of one of the pair of dock couplers to enable an easy alignment and engagement of associated first and second connectors of another of the pair of dock couplers.

9. The dock system of claim 8, wherein the second connector of each of the pair of dock couplers includes a swivel socket extending inside the slot and adapted to swivel relative to the rod to facilitate the yaw, the pitch, and the roll motion of the second dock element relative to the first dock element.

10. The dock system of claim 8, wherein the pin defines a radially extending opening to receive a lynch pin to lock the first connector with the associated second connector to prevent any undesired removal of the pin from the slot.

11. The dock system of claim 8, wherein the first connector of each of the pair of dock couplers includes a flange adapted to be connected to the first dock element to secure the first connector to the first dock element, and the second connector of each of the pair of dock couplers includes a plate adapted to be connected to the second dock element to secure the second connector to the second dock element.

12. The dock system of claim 8, wherein the slot is an elliptical slot a major axis greater than a diameter of the pin to enable the roll motion.

13. The dock system of claim 8, wherein the second connector of each of pair of dock couplers includes a pair of arms arranged spaced apart and parallel to each other, and the rod extends between the arms and extends through the arms, wherein the arms are arranged to rotate about a central axis of the rod to enable the pitch motion of the second dock element relative to the first dock element.

14. The dock system of claim 8, wherein the rod is adapted to rotate about a central axis of the pin facilitate the yaw motion of the second dock element relative to the first dock element.
